(19) United States
(12) Patent Application Publication
(10) Pub. No.: US 2018/0001699 A1
(43) Pub. Date: Jan. 4, 2018

(54) NON-PNEUMATIC TIRE

(71) Applicant: BRIDGESTONE CORPORATION, Tokyo (JP)

(72) Inventor: Takanori SHOJI, Tokyo (JP)

(73) Assignee: BRIDGESTONE CORPORATION, Tokyo (JP)

(21) Appl. No.: 15/543,066

(22) PCT Filed: Jan. 5, 2016
(86) PCT No.: PCT/JP2016/050091

§ 371 Date: Jul. 12, 2017

(30) Foreign Application Priority Data
Jan. 15, 2015 (JP) 2015-005720

(51) Int. Cl. B60B 9/04; B60C 7/26; B60C 7/18; B60C 7/06; B60C 11/03; B60C 7/10

(52) U.S. Cl. CPC B60B 9/04; B60C 7/18; B60C 7/06; B60C 7/26; B60C 7/102; B60C 11/0309

(57) ABSTRACT

There is provided a non-pneumatic tire (1) including: an attachment body (11) that is attached to an axle; a ring-shaped body (13) that surrounds the attachment body (11) from an outside in a tire radial direction, a plurality of connection members (15) that are disposed between the attachment body (11) and the ring-shaped body (13) along a tire peripheral direction and connect the attachment body (11) and the ring-shaped body (13) to each other, and a cylindrical tread member (16) that is externally mounted on the ring-shaped body (13), in which the ring-shaped body (13) and the connection member (15) are integrally formed by a injection molding in which a molding material is injected from the connection member (15) side toward the ring-shaped body (13) side, in which the tread member (16) includes a base rubber portion (41) that is positioned at an inside in the tire radial direction and a cap rubber portion (42) that is positioned at an outside of the base rubber portion (41) in the tire radial direction, in which rigidity of the base rubber portion (41) is lower than rigidity of the cap rubber portion (42), and in which the base rubber portion (41) is disposed at least in a portion positioned between the connection members (15) adjacent to each other in the tire peripheral direction in the ring-shaped body (13).

### Priority is claimed on Japanese Patent Application No. 2015-005720, filed on Jan. 15, 2015, the content of which is incorporated herein by reference.

### TECHNICAL FIELD

The present invention relates to a non-pneumatic tire which does not require filling of pressurized air therein upon use thereof.

### BACKGROUND ART

In the related art, a non-pneumatic tire disclosed in the following Patent Document 1 is known. The non-pneumatic tire includes an attachment body which is attached to an axle, an outer tube body which surrounds the attachment body from an outside in a tire radial direction, a plurality of connection members which are disposed between the attachment body and the outer tube body along a tire peripheral direction and connect the attachment body and the outer tube body, and a cylindrical tread member which is externally mounted on the outer tube body.

### CITATION LIST

### Patent Document

[Patent Document 1] Japanese Unexamined Patent Application, First Publication No. 2014-91453

### SUMMARY OF INVENTION

### Technical Problem

According to the inventor of the present invention, in the non-pneumatic tire of the related art described above, in a case where the outer tube body and the connection member are integrally formed by injection molding in which the molding material is injected from a connection member side toward an outer tube body side, the strength of the weld formed on the outer tube body is lower than that of the other portion. For example, when a load is applied to the tread member from the road surface and the stress generated in the tread member is transferred to the outer tube body, the outer tube body is likely to be damaged starting from a weld thereof, and thus there is room for improvement in increasing the strength thereof.

The invention has been made in view of the above circumstances, and an object thereof is to improve strength of the non-pneumatic tire.

### Solution to Problem

In order to solve the above problem, the invention proposes the following means.

According to the present invention, there is provided a non-pneumatic tire including: an attachment body that is attached to an axle, an outer tube body that surrounds the attachment body from the outside in a tire radial direction, a plurality of connection members that are disposed between the attachment body and the outer tube body along a tire peripheral direction and connect the attachment body and the outer tube body, and a cylindrical tread member that is externally mounted on the outer tube body, in which the outer tube body and the connection member are integrally formed by injection molding in which the molding material is injected from a connection member side toward an outer tube body side, in which the tread member includes a base rubber portion which is positioned at an inside thereof in the tire radial direction and a cap rubber portion which is positioned at an outside of the base rubber portion in the tire radial direction, and in which rigidity of the base rubber portion is lower than the rigidity of the cap rubber portion and, in which the base rubber portion is disposed at least in a portion positioned between the connection members adjacent to each other in the tire peripheral direction in the outer tube body.

### Advantageous Effects of Invention

According to the non-pneumatic tire of the present invention, the strength thereof can be improved.

### BRIEF DESCRIPTION OF DRAWINGS

FIG. 1 is a view showing an embodiment of a non-pneumatic tire according to the invention and a schematic perspective view showing a state where a portion of the non-pneumatic tire is disassembled.

FIG. 2 is a tire side view of the non-pneumatic tire shown in FIG. 1 viewed from an outside of a vehicle body in a tire width direction.

FIG. 3 is an enlarged view showing a main portion of FIG. 2.

FIG. 4 is a tire side view of a first divided case body viewed from the outside of the vehicle body in the tire width direction, or a tire side view of a second divided case body viewed from the inside of the vehicle body in the tire width direction, in the non-pneumatic tires shown in FIG. 1.

FIG. 5 is a side view of a main portion including a ring-shaped body and a tread member viewed from the tire width direction, in the non-pneumatic tire shown in FIG. 1, and is a view in which the tread member is limited in cross section.

FIG. 6 is a side view of a main portion including a ring-shaped body and a tread member viewed from the tire width direction, in another embodiment of the non-pneumatic tire according to the present invention, and is a view in which the tread member is limited in cross section.

FIG. 7 is an enlarged view showing a main portion of FIG. 5.

### DESCRIPTION OF EMBODIMENTS

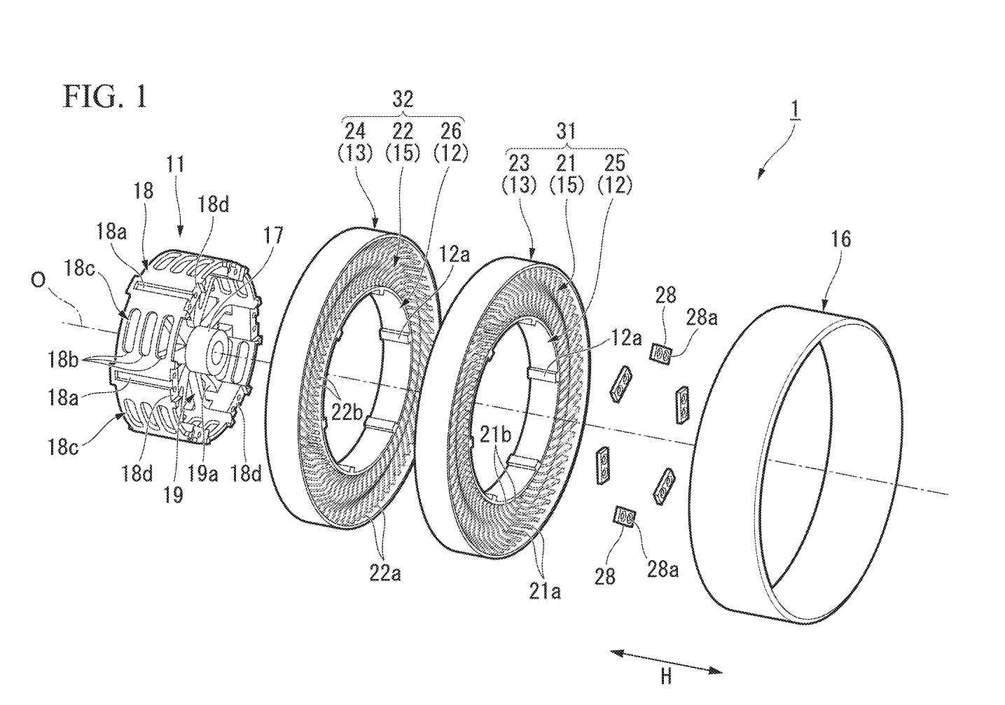

Hereinafter, an embodiment according to the invention will be described with reference to FIG. 1 to FIG. 5.

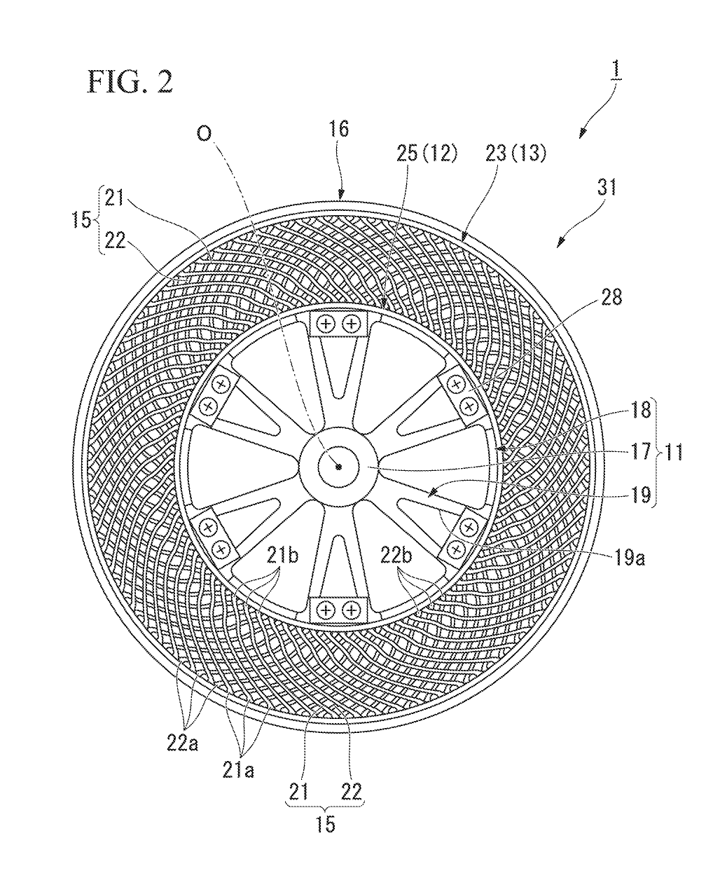

As shown in FIG. 1 and FIG. 2, a non-pneumatic tire 1 of the present embodiment includes an attachment body 11 which is attached to an axle (not shown), a cylindrical ring-shaped body 13 (outer tube body) which surrounds the attachment body 11 from an outside in a tire radial direction, a plurality of connection members 15 which are disposed between the attachment body 11 and the ring-shaped body 13 along a tire peripheral direction and connect the attachment body 11 and the ring-shaped body 13 to each other to be relatively elastically displaceable, and a cylindrical tread member 16 which is externally mounted to the ring-shaped body 13.

The non-pneumatic tire 1 of the present embodiment may be used for a two-wheeled vehicle such as a bicycle or the like, may drive in a state of being a camber angle of about 30 degrees, and may be adapted for small vehicles or the like which is defined in Japanese Industrial Standard JIS T 9208 and is driven at a low speed such as a handle type electric wheelchair. In addition, the size of the non-pneumatic tire 1 is not particularly limited, but may be 3.00 to 8 or the like, for example. In addition, the non-pneumatic tire 1 may be used for a passenger car. The size, in this case, is not particularly limited, and it may also be, for example, 155/65R13 or the like.

The attachment body 11, the ring-shaped body 13, and the tread member 16 described above are disposed coaxially with a common shaft, respectively. Hereinafter, this common axis is referred to as an axis O, a direction along the axis O is referred to as the tire width direction H, a direction orthogonal to the axis O is referred to as the tire radial direction, and a direction orbiting around the axis O is referred to as a tire peripheral direction. The attachment body 11, the ring-shaped body 13, and the tread member 16 are disposed in a state where center portions thereof in the tire width direction H are coincident with each other. In addition, the outer diameter of the ring-shaped body 13 is equal regardless of the position in the tire peripheral direction.

The attachment body 11 includes a mounting tube portion 17 on which a tip portion of the axle is mounted, an outer ring portion 18 which surrounds the mounting tube portion 17 from the outside in the tire radial direction, and a plurality of ribs 19 which connects the mounting tube portion 17 and the outer ring portion 18 to each other.

The mounting tube portion 17, the outer ring portion 18, and the ribs 19 are integrally formed of a metal material such as an aluminum alloy, for example. The mounting tube portion 17 and the outer ring portion 18 are respectively formed in a cylindrical shape and are disposed coaxially with an axis line O. The plurality of ribs 19 are disposed at an equal interval in the peripheral direction, for example.

On the outer peripheral surface of the outer ring portion 18, a plurality of key groove portions 18a which is depressed inward in the tire radial direction and extends in the tire width direction H are formed at intervals in the tire peripheral direction. The key groove portion 18a is open only on the outer side (a first side) of the vehicle body in the tire width direction H on the outer peripheral surface of the outer ring portion 18 and is closed on the inner side (a second side) of the vehicle body in the tire width direction H.

In the outer ring portion 18, in a portion positioned between the adjacent key groove portions 18a in the tire peripheral direction, a plurality of lightening holes 18b penetrating the outer ring portion 18 in the tire radial direction are formed at intervals in the tire width direction H. A plurality of hole rows 18c formed by the plurality of lightening holes 18b are formed at intervals in the tire peripheral direction. Similarly, each rib 19 also has a lightening hole 19a penetrating the rib 19 in the tire width direction H.

A recessed portion 18d into which the plate material 28 having a through hole 28a is fitted is formed at a position corresponding to the key groove portion 18a on an edge of the outer side of the vehicle body in the tire width direction H in the outer ring portion 18. The recessed portion 18d is recessed toward the inner side of the vehicle body in the tire width direction H. In addition, a female thread portion which communicates with the through hole 28a of the plate material 28 fitted in the recessed portion 18d is formed on a wall surface of the wall surfaces defining the recessed portion 18d facing the outer side of the vehicle body in the tire width direction H.

A plurality of the through holes 28a are formed on the plate material 28 at intervals in the tire peripheral direction.

Similarly, a plurality of female thread portions are formed on the wall surface of the recessed portion 18d at intervals in the tire peripheral direction. In the example shown, two through holes 28a and two female threaded portions are formed, but the number thereof is not limited to two.

A cylindrical exterior body 12 is externally fitted to the attachment body 11. A ridge portion 12a protruding inward in the tire radial direction and extending over the entire length in the tire width direction H is formed on the inner peripheral surface of the exterior body 12. A plurality of ridge portions 12a are formed at intervals in the tire peripheral direction on the inner peripheral surface of the exterior body 12 and are fitted respectively in the key groove portions 18a formed on the attachment body 11.

Then, in a state where the ridge portion 12a is fitted in the key groove portion 18a, the exterior body 12 is fixed to the attachment body 11 by a bolt (not shown) being screwed into the female threaded portion through the through hole 28a of the plate material 28 fitted in the recessed portion 18d.

Of the wall surfaces defining the key groove portion 18a, a pair of side wall surfaces opposed to each other in the tire peripheral direction and the bottom wall surface are formed so as to be orthogonal to each other. In addition, a pair of side wall surfaces rising from the inner peripheral surface of the exterior body 12 and a top wall surface facing inward in the tire radial direction in the outer surface of the ridge portion 12a are also formed to be orthogonal in the same manner. The sizes of the ridge portion 12a and the key groove portion 18a in the tire peripheral direction are equal to each other.

With such a configuration, the ridge portion 12a is fitted in the key groove portion 18a with less rattling and high precision.

The connection member 15 connects the outer peripheral surface side of the attachment body 11 and the inner peripheral surface side of the ring-shaped body 13 to each other to be relatively elastically displaceable. In the example shown, the connection member 15 includes a first connection plate 21 and a second connection plate 22 that connects the outer peripheral surface of the exterior body 12 externally fitted to the attachment body 11 and the inner peripheral surface of the ring-shaped body 13 to each other. Both of the first connection plate 21 and the second connection plate 22 are elastically deformable plate materials.

A plurality of the first connection plates 21 are disposed along the tire peripheral direction, at a position on the outer side of the vehicle body along the tire width direction H. A plurality of second connection plates 22 are disposed along the tire peripheral direction, at a position on the inner side of the vehicle body along the tire width direction H. In other words, the first connection plate 21 and the second connection plate 22 are disposed spaced apart from each other in the tire width direction H and a plurality of the first connection plates 21 and the second connection plates 22 are disposed at respective positions along the tire peripheral direction. For example, 60 first connection plates 21 and 60 second connection plates 22 are provided along the tire peripheral direction.

The plurality of connection members 15 are disposed separately at positions that are rotationally symmetrical about the axis O between the exterior body 12 and the ring-shaped body 13. In addition, all the connection members 15 have the same shape and the same size to each other, and the lateral width of the connection member 15 along the tire width direction H is smaller than the lateral width of the ring-shaped body 13 along the tire width direction H.

The first connection plates 21 adjacent to each other in the tire peripheral direction are not in contact with each other. Similarly, the second connection plates 22 adjacent to each other in the tire peripheral direction are also not in contact with each other. In addition, the first connection plate 21 and the second connection plate 22 adjacent to each other in the tire width direction H are also not in contact with each other. Further, the first connection plate 21 and the second connection plate 22 have the same lateral width and thickness along the tire width direction H.

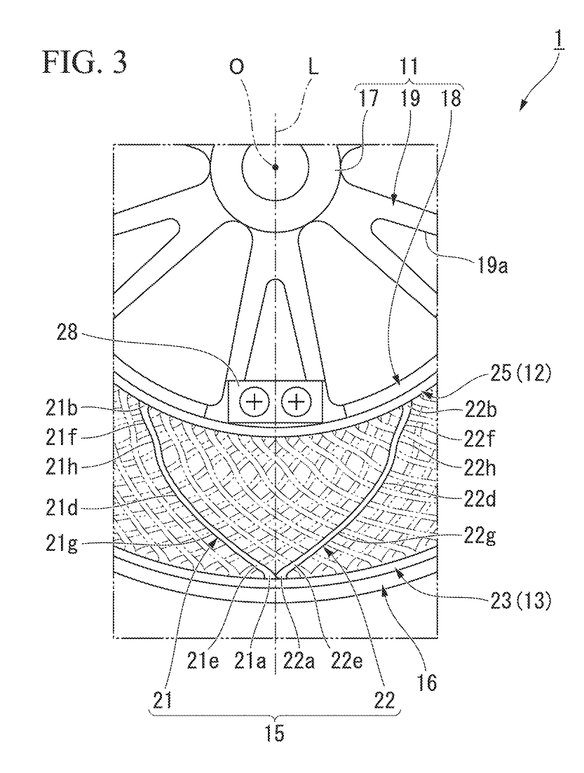

As shown in FIG. 3, the outer end portion (a first end portion) 21a of the first connection plate 21 connected to the ring-shaped body 13 is positioned on a first side of the inner end portion (a second end portion) 21b connected to the exterior body 12 in the tire peripheral direction. On the other hand, the outer end portion (a first end portion) 22a of the second connection plate 22 connected to the ring-shaped body 13 is positioned on a second side of the inner end portion (the second end portion) 22b connected to the exterior body 12 in the tire peripheral direction.

Each of the outer end portions 21a and 22a of the first connection plate 21 and the second connection plate 22 constituting one connection member 15 is connected to the same position in the tire peripheral direction in a state where the positions thereof in the tire width direction H are different from each other on the inner peripheral surface of the ring-shaped body 13.

In the first connection plate 21 and the second connection plate 22, a plurality of curved portions 21d to 21f and 22d to 22f curved in the tire peripheral direction are formed on an intermediate portion positioned between the outer end portions 21a and 22a and the inner end portions 21b and 22b.

The plurality of curved portions 21d to 21f and 22d to 22f are formed along the extending direction of the first connection plate 21 and the second connection plate 22 in a tire side view which is viewed the non-pneumatic tire 1 from the tire width direction H. In the example shown, the plurality of curved portions 21d to 21f in the first connection plate 21 and the plurality of curved portions 22d to 22f in the second connection plate 22 are formed such that the first connection plate 21 and the second connection plate 22 are adjacent to each other in an extending direction and the curved directions thereof are opposite to each other.

The plurality of curved portions 21d to 21f formed on the first connection plate 21 include a first curved portion 21d which is curved so as to protrude toward the second side in the tire peripheral direction, a second curved portion 21e which is positioned between the first curved portion 21d and the outer end portion 21a and is curved so as to protrude toward the first side in the tire peripheral direction, and a third curved portion 21f which is positioned between the first curved portion 21d and the inner end portion 21b and is curved so as to protrude toward the first side in the tire peripheral direction. The second curved portion 21e is connected to the outer end portion 21a.

The plurality of curved portions 22d to 22f formed on the second connection plate 22 include a first curved portion 22d which is curved so as to protrude toward the first side in the tire peripheral direction, a second curved portion 22e which is positioned between the first curved portion 22d and the outer end portion 22a and is curved so as to protrude toward the second side in the tire peripheral direction, and a third curved portion 22f which is positioned between the first curved portion 22d and the inner end portion 22b and is curved so as to protrude toward the second side in the tire peripheral direction. The second curved portion 22e is connected to the outer end portion 22a.

In the example shown, the first curved portions 21d and 22d are formed to have a larger curvature radius in a tire side view than the second curved portions 21e and 22e and the third curved portions 21f and 22f, and are disposed on the center portions in an extending direction of the first connection plate 21 and the second connection plate 22.

The lengths of the first connection plate 21 and the second connection plate 22 are equal to each other. The inner end portions 21b and 22b of the first connection plate 21 and the second connection plate 22 respectively are connected to positions on the outer peripheral surface of the exterior body 12 spaced apart on the first side and the second side by the same distance respectively in the tire peripheral direction about the axis O from a position facing the outer end portions 21a and 22a in the tire radial direction on the outer peripheral surface of the exterior body 12.

Specifically, the inner end portions 21b and 22b of the first connection plate 21 and the second connection plate 22 are connected to the outer peripheral surface of the exterior body 12 so that an angle formed between the line connecting the outer end portion 21a and the inner end portion 21b of the first connection plate 21 and the line connecting the outer end portion 22a and the inner end portion 22b of the second connection plate 22 has, for example, an angle between 20° and 135°.

In addition, the first curved portions 21d and 22d, the second curved portions 21e and 22e, and the third curved portions 21f and 22f of the first connection plate 21 and the second connection plate 22 protrude in the opposite direction of the tire peripheral direction to each other and to the same size, respectively.

With the configuration described above, as shown in FIG. 3, the shape of each of the connection members 15 in a tire side view extends along the tire radial direction and is line-symmetrical about a virtual line L which passes through each of the outer end portion 21a and 22a of the first connection plate 21 and the second connection plate 22 as a symmetrical axis.

The exterior body 12, the ring-shaped body 13, and the plurality of connection members 15 described above are integrally formed of a synthetic resin material, for example. The synthetic resin material may be, for example, only one type of resin material, a mixture containing two or more types of resin materials, or a mixture containing at least one type of resin material and at least one type of elastomer and further, may also include an antioxidant, a plasticizer, a filler, or an additive such as a pigment, for example.

Incidentally, as shown in FIG. 1, the exterior body 12 is divided into a first exterior body 25 positioned on the outer side of the vehicle body in the tire width direction H and a second exterior body 26 positioned on the inner side of the vehicle body in the tire width direction H. Similarly, the ring-shaped body 13 is divided into a first ring-shaped body 23 (divided tube) positioned on the outer side of the vehicle body in the tire width direction H and a second ring-shaped body 24 (divided tube) positioned on the inner side of the vehicle body in the tire width direction H. In the ring-shaped body 13, the ends of the first and second ring-shaped bodies 23 and 24 (a plurality of divided tubes) in the tire width direction H disposed adjacent to each other in the tire width direction H are connected to each other.

In the example shown, the exterior body 12 and the ring-shaped body 13 are divided at the center portion in the tire width direction H, respectively.

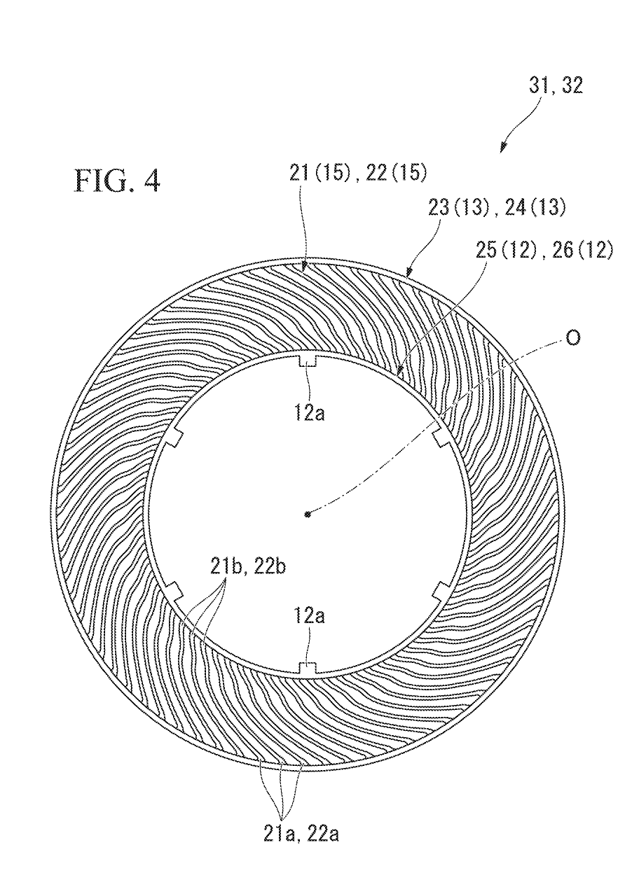

Then, as shown in FIG. 4, the first exterior body 25 and the first ring-shaped body 23 are integrally formed with the first connection plate 21 by injection molding. The second exterior body 26 and the second ring-shaped body 24 are integrally formed with the second connection plate 22 by injection molding.

Hereinafter, a unit in which the first exterior body 25, the first ring-shaped body 23, and the first connection plate 21 are integrally formed is referred to as a first divided case body 31 and a unit in which the second exterior body 26, the second ring-shaped body 24 and the second connection plate 22 are integrally formed is referred to as a second divided case body 32.

Each of the divided case bodies 31 and 32 is integrally formed by injection molding, in which a molding material is injected from the connection member 15 side toward the ring-shaped body 13 side.

As an example, the first divided case body 31, as a mold, includes a cavity that has an inner space for molding the first exterior body 25, an outer space for molding the first ring-shaped body 23, and an intermediate space for molding the first connection plate 21 and a gate to the cavity is configured so as to be connected to the inner space. In this mold, the first divided case body 31 is formed by the molding material being injected from the gate into the cavity and being supplied from the inner space to the outer space through the intermediate space. At this time, in the intermediate space, the molding material which has passed through each portion forming the first connection plate 21 adjacent in the tire peripheral direction flows so as to approach each other in the tire peripheral direction in the outer space based on an injection pressure thereof and thus the weld is formed in the portion of the first ring-shaped body 23 interposed in the tire peripheral direction between the outer end portions 21a of the first connection plates 21 adjacent to each other in the tire peripheral direction.

These points are also similarly applied to the second divided case body 32.

The edges of the first ring-shaped body 23 and the second ring-shaped body 24 facing in the tire width direction H are connected to each other, for example, by welding, fusing, adhesion or the like and a joining portion (not shown) which connects the edges of the first and second ring-shaped bodies 23 and 24 in the tire width direction H to each other is provided on the ring-shaped body 13. In the case of welding, for example, hot plate welding or the like may be performed. Similarly, the first exterior body 25 and the second exterior body 26 are in contact in the edges facing in the tire width direction H.

However, the first exterior body 25 and the second exterior body 26 may be formed so that the lateral widths thereof along the tire width direction H is smaller than that of the first ring-shaped body 23 and the second ring-shaped body 24.

In this case, in the first exterior body 25 and the second exterior body 26, when the first divided case body 31 and the second divided case body 32 are connected to each other, the edges facing in the tire width direction H are spaced apart from each other in the tire width direction. Therefore, for example, generation of burrs can be prevented on the inner peripheral surface of the exterior body 12 externally fitted to the attachment body 11.

As shown in FIG. 4, the first divided case body 31 and the second divided case body 32 have the same shape and the same size as each other. When the first divided case body 31 and the second divided case body 32 are integrally connected to each other as described above, in order to make each connection member 15 line-symmetrical as seen in a tire side view, the first divided case body 31 and the second divided case body 32 are aligned with each other in the tire peripheral direction. In addition, in a state where the directions of the first divided case body 31 and the second divided case body 32 are opposite to each other in the tire width direction H, the edges of the first ring-shaped body 23 and the second ring-shaped body 24 in the tire width direction H are collided and connected to each other.

Thereafter, by providing the tread member 16 to the first divided case body 31 and the second divided case body 32 integrally combined with each other, the non-pneumatic tire 1 can be obtained.

As shown in FIG. 1, the tread member 16 is formed in a cylindrical shape and integrally covers the entire outer peripheral surface side of the ring-shaped body 13. The inner diameter of the tread member 16 is equal over the entire periphery thereof, and the inner peripheral surface of the tread member 16 is in close contact with the outer peripheral surface of the ring-shaped body 13 over the entire area thereof. The inner diameter of the tread member 16 is the distance along the tire radial direction between the inner peripheral surface of the tread member 16 and the axis O. The outer peripheral surface of the tread member 16 is formed in a perfect circular shape in a cross-sectional view taken along an orthogonal plane orthogonal to the axis O and the outer diameter of the tread member 16 is equal over the entire periphery thereof. The outer diameter of the tread member 16 is the distance along the tire radial direction between the outer peripheral surface of the tread member 16 and the axis 0.

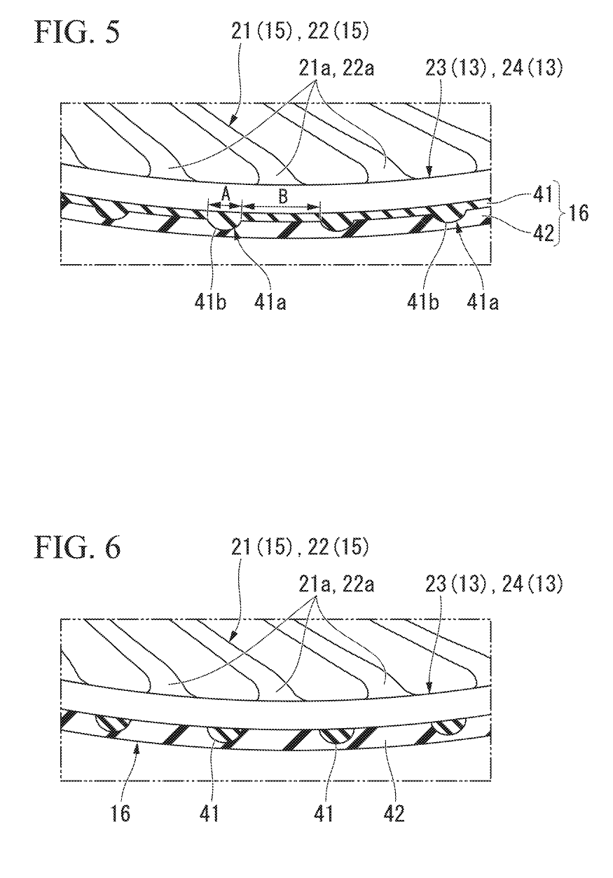

As shown in FIG. 5, the tread member 16 includes a base rubber portion 41 positioned on the inner side in the tire radial direction and a cap rubber portion 42 positioned outside of the base rubber portion 41 in the tire radial direction. Both the base rubber portion 41 and the cap rubber portion 42 extend over the entire periphery of the ring-shaped body 13, and the tread member 16 has a two-layer structure of the base rubber portion 41 and the cap rubber portion 42.

The base rubber portion 41 is disposed at least in a portion (portion where weld is formed) positioned between the connection members 15 adjacent in the tire peripheral direction in the ring-shaped body 13, and in the example shown, as described above extends over the entire periphery of the ring-shaped body 13. A portion (hereinafter referred to as “weld protecting portion”) 41a of the base rubber portion 41 positioned between the connection members 15 adjacent to each other in the tire peripheral direction on the outer peripheral surface of the ring-shaped body 13 is thicker than other portion thereof and is formed to be large in the tire radial direction. In the present embodiment, the portion of the ring-shaped body 13 positioned between the connection members 15 adjacent to each other in the tire peripheral direction is a portion of the first ring-shaped body 23 (or second ring-shaped body 24) interposed in the tire peripheral direction by each outer end portion 21a of the first connection plate 21 (or each outer end portion 22a of the second connection plate 22) adjacent to each other in the tire peripheral direction.

The weld protecting portion 41a has a curved surface shape that protrudes toward the outside in the tire radial direction in a cross-sectional view taken along an orthogonal plane orthogonal to the axis O. In the cross-sectional view taken along the orthogonal plane orthogonal to the axis O, the curvature of the outer surface 41b facing the outside in the tire radial direction in the weld protecting portion 41a is larger than the curvature of the outer peripheral surface of the tread member 16.

The thickness (size in the tire radial direction) of the excluded portion which is a portion of the base rubber portion 41 other than the weld protecting portion 41a is the same regardless of the position in the tire radial direction.

In addition, when the lateral width in the tire peripheral direction of the weld protecting portion 41a of the base rubber portion 41 is referred to as A and the distance between the weld protecting portions 41a in the tire peripheral direction is referred to as B, the distance B between the weld protecting portions 41a is longer than the lateral width A of the weld protecting portion 41a.

The cap rubber portion 42 covers the base rubber portion 41 from the outside to the entire periphery thereof in the tire radial direction, and the base rubber portion 41 is not exposed to the outside in the tire radial direction. The outer peripheral surface of the cap rubber portion 42 constitutes the outer peripheral surface of the tread member 16.

Here, the base rubber portion 41 and the cap rubber portion 42 are made of two types of rubbers which are different from each other. The base rubber portion 41 and the cap rubber portion 42 are formed of vulcanized rubber in which natural rubber and/or a rubber composition are vulcanized. The rigidity of the base rubber portion 41 is lower than the rigidity of the cap rubber portion 42. In the present embodiment, the rubber hardness Gb of the base rubber portion 41 is lower than the rubber hardness Gc of the cap rubber portion 42. The rubber hardness Gb of the base rubber portion 41 and the rubber hardness Gc of the cap rubber portion 42 satisfy 30<Gb<Gc<80. The rubber hardness (Japanese Industrial Standard JIS-A hardness) was measured by a durometer A in accordance with Japanese Industrial Standard JIS K 6253. In addition, the elastic modulus Eb of the base rubber portion 41 is lower than the elastic modulus Ec of the cap rubber portion 42. The elastic modulus Eb of the base rubber portion 41 and the elastic modulus Ec of the cap rubber portion 42 satisfy 0.1 MPa<Eb<Ec<100 MPa. The elastic modulus was measured by a tensile tester according to Japanese Industrial Standard JIS K 6254: 2010.

As described above, according to the non-pneumatic tire 1 according to the present embodiment, since the rigidity of the base rubber portion 41 positioned on the inner side in the tire radial direction is lower than the rigidity of the cap rubber portion 42 positioned outside in the tire radial direction, the stress generated in the tread member 16 can be dispersed in the base rubber portion 41 when a load is applied to the tread member 16. Since the base rubber portion 41 is disposed at least in a portion positioned between the connection members 15 adjacent to each other in the tire peripheral direction in the ring-shaped body 13, by dispersing the stress as described above, the stress transferred from the tread member 16 to the weld can be suppressed.

On the other hand, since the cap rubber portion 42 having high rigidity is positioned outside in the tire radial direction with respect to the base rubber portion 41 having low rigidity, wear resistance and impact resistance of the tread member 16 can be secured by the cap rubber portion 42 and the driving stability of the non-pneumatic tire 1 can also be secured.

As described above, while the stress transferred to the weld is suppressed by the base rubber portion 41, the wear resistance, the impact resistance of the tread member 16 can be secured by the cap rubber portion 42 and thus the strength of the non-pneumatic tire 1 can be improved.

In addition, since the base rubber portion 41 extends over the entire periphery of the outer peripheral surface of the ring-shaped body 13 and the weld protecting portion 41a of the base rubber portion 41 is thicker than the other portions, the stress can be effectively dispersed in a wide range in the weld protecting portion 41a in the tire peripheral direction.

In addition, since the rubber hardness Gb of the base rubber portion 41 is lower than the rubber hardness Gc of the cap rubber portion 42, stress generated in the tread member 16 can be effectively dispersed in the base rubber portion 41.

Furthermore, since the rubber hardness Gb of the base rubber portion 41 and the rubber hardness Gc of the cap rubber portion 42 satisfy 30<Gb<Gc<80, the stress generated in the tread member 16 can be more effectively dispersed in the base rubber portion 41.

In addition, since the elastic modulus Eb of the base rubber portion 41 is lower than the elastic modulus Ec of the cap rubber portion 42, stress generated in the tread member 16 can be effectively dispersed in the base rubber portion 41.

Furthermore, since the elastic modulus Eb of the base rubber portion 41 and the elastic modulus Ec of the cap rubber portion 42 satisfy 0.1 MPa<Eb<Ec<100 MPa, the stress generated in the tread member 16 can be more effective dispersed in the base rubber portion 41.

The technical scope of the invention is not limited to the above embodiment, and various modifications can be made without departing from the scope of the invention.

For example, in the present invention, it is also possible to use a non-pneumatic tire as shown in FIG. 6. In this non-pneumatic tire, the base rubber portion 41 is disposed only in portions of the ring-shaped body 13 positioned between the connection members 15 adjacent to each other in the tire peripheral direction. A plurality of the base rubber portions 41 are intermittently disposed in the tire peripheral direction. Each one of the base rubber portions 41 has a curved surface shape protruding toward the outside in the tire radial direction in a cross-sectional view taken along an orthogonal plane orthogonal to an axis O.

In the cross-sectional view taken along the orthogonal plane orthogonal to the axis O, the curvature of the outer surface of each one of the base rubber portions 41 facing the outside in the tire radial direction is larger than the curvature of the outer peripheral surface of the tread member 16.

For example, in the above embodiment, there is shown a configuration in which each of one first connection plate 21 and one second connection plate 22 is provided as the connection member 15, but, instead of this, a plurality of first connection plates 21 and a plurality of second connection plates 22 may be provided for one connection members 15 so that positions thereof in the tire width direction H are different from each other. In addition, a plurality of connection members 15 may be provided between the exterior body 12 and the ring-shaped body 13 along the tire width direction H.

In addition, instead of the above embodiment, the inner end portions 21b and 22b of the first connection plate 21 and the second connection plate 22 may be respectively connected to positions opposite to each other, for example, interposing the axis O in the outer peripheral surface of the exterior body 12 in the tire radial direction. Alternatively, on the outer peripheral surface of the exterior body 12, the inner end portions 21b and 22b of the first connection plate 21 and the second connection plate 22 may be connected to a position opposing to each of the outer end portions 21a and 22a of the first connection plate 21 and the second connection plate 22 in the tire radial direction. In addition, instead of the above embodiment, the outer end portions 21a and 22a of the first connection plate 21 and the second connection plate 22 may be respectively connected to different positions from each other in the tire peripheral direction in the inner peripheral surface of the ring-shaped body 13.

Furthermore, in the above embodiment, a gap in the tire width direction H may be provided or may not be provided between the first exterior body 25 and the second exterior body 26. In addition, the exterior body 12 and the ring-shaped body 13 may be divided or may not be divided into three or more in the tire width direction H.

In addition, the exterior body 12 and the attachment body 11 may be integrally formed. In other words, the exterior body 12 may be included in the attachment body 11.

Furthermore, in the embodiment described above, the connection member 15 is indirectly connected to the attachment body 11 via the exterior body 12, but it is not limited thereto. For example, the connection member 15 may be directly connected to the attachment body 11.

Besides, each configuration (constituent elements) described in the embodiment described above, modification example, and still further writing may be combined with each other without departing from the scope of the invention and in addition, additions, omissions, substitutions, and other changes to the configuration are possible. In addition, the invention is not limited to the embodiments described above and is limited only by the claims.

Next, a verification test on the operational effects described above was carried out.

As an example, the non-pneumatic tire 1 shown in FIGS. 1 to 5 was used, and as a comparative example, a non-pneumatic tire in which the tread member 16 has a single layer structure made of the same material as the cap rubber portion 42 is used in the non-pneumatic tire of the example.

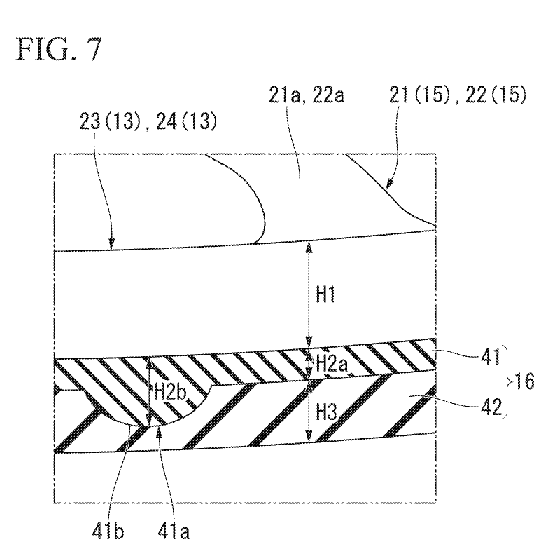

As shown in FIG. 7, the thickness of the ring-shaped body 13 of these non-pneumatic tires is set to H1, the thickness of the excluded portion of the base rubber portion 41 is set to H2a, the thickness of the weld protecting portion 41a of the base rubber portion 41 is set to H2b and the thickness of the cap rubber portion 42 is set to H3. The thickness H1 of the ring-shaped body 13 is larger than the thickness H2a of the excluded portion of the base rubber portion 41, the thickness H2b of the weld protecting portion 41a of the base rubber portion 41, and the thickness H3 of the cap rubber portion 42, that is, the relationship which is H1>H2a, H2b, H3 is established. Further, the thickness H1 of the ring-shaped body 13 is equal to or larger than the sum of the thickness H2a of the excluded portion of the base rubber portion 41 and the thickness H3 of the cap rubber portion 42 or is equal to or greater than the sum of the thickness H2b of the weld protecting portion 41a of the base rubber portion 41 and the thickness H3 of the cap rubber portion 42, that is, the relationship which is H1≧H2a+H3 or H1≧H2b+H3 is established.

The outer diameters of these non-pneumatic tires and each dimension of H1, H2a, H2b, and H3 were set to the sizes shown in Table 1 below. The unit of the value described in the second line of Table 1 is mm.

TABLE 1

| Tire Outer Diameter R | H1 | H2a | H2b | H3 |
|---|---|---|---|---|
| 150 | 6 | 2 | 4 | 4 |

(unit: mm)

The rubber hardness and elastic modulus of the base rubber portion 41 and the cap rubber portion 42 in the non-pneumatic tire 1 of the example were set to the sizes shown in Table 2 below.

TABLE 2

| | Base Rubber Portion | Cap Rubber Portion |
|---|---|---|
| Rubber Hardness | 60 | 65 |
| Elasticity Modulus (MPa) | 35 | 40 |

For these two types of non-pneumatic tires, the driving distance was measured until the tire was broken by using a drum tester and driving at 60 km/h in a state where a load of 1000 N is applied.

As a result, it was confirmed that the driving distance was increased by 20% in the non-pneumatic tire 1 of the example compared to the non-pneumatic tire of the comparative example.

### INDUSTRIAL APPLICABILITY

According to the present invention, the strength of the non-pneumatic tire can be improved.

### REFERENCE SIGNS LIST

1 non-pneumatic tire

11 attachment body

13 ring-shaped body (outer tube body)

15 connection member

16 tread member

41 base rubber portion

42 cap rubber portion

1. A non-pneumatic tire comprising:
an attachment body that is attached to an axle;
an outer tube body that surrounds the attachment body from an outside in a tire radial direction;
a plurality of connection members that are disposed between the attachment body and the outer tube body along a tire peripheral direction and connect the attachment body and the outer tube body to each other; and
a cylindrical tread member that is externally mounted on the outer tube body,
wherein the outer tube body and the connection member are integrally formed by an injection molding in which a molding material is injected from the connection member side toward the outer tube body side,
wherein the tread member includes a base rubber portion that is positioned at an inside in the tire radial direction and a cap rubber portion that is positioned at an outside of the base rubber portion in the tire radial direction,
wherein rigidity of the base rubber portion is lower than rigidity of the cap rubber portion, and
wherein the base rubber portion is disposed at least in a portion positioned between the connection members adjacent to each other in the tire peripheral direction in the outer tube body.

2. The non-pneumatic tire according to claim 1,
wherein the base rubber portion extends over the entire periphery of the outer tube body, and
wherein a portion, in the base rubber portion, which is positioned between the connection members adjacent to each other in the tire peripheral direction on an outer peripheral surface of the outer tube body is thicker than other portions of the base rubber portion.

3. The non-pneumatic tire according to claim 1,
wherein the rubber hardness Gb of the base rubber portion is lower than the rubber hardness Gc of the cap rubber portion.

4. The non-pneumatic tire according to claim 2,
wherein the rubber hardness Gb of the base rubber portion is lower than the rubber hardness Gc of the cap rubber portion.

5. The non-pneumatic tire according to claim 3,
wherein the rubber hardness Gb of the base rubber portion and the rubber hardness Gc of the cap rubber portion satisfy 30<Gb<Gc<80.

6. The non-pneumatic tire according to claim 4,
wherein the rubber hardness Gb of the base rubber portion and the rubber hardness Gc of the cap rubber portion satisfy 30<Gb<Gc<80.

7. The non-pneumatic tire according to claim 1,
wherein the elastic modulus Eb of the base rubber portion is lower than the elastic modulus Ec of the cap rubber portion.

8. The non-pneumatic tire according to claim 7,
wherein the elastic modulus Eb of the base rubber portion and the elastic modulus Ec of the cap rubber portion satisfy 0.1 MPa<Eb<Ec<100 MPa.

9. The non-pneumatic tire according to claim 2,
wherein the elastic modulus Eb of the base rubber portion is lower than the elastic modulus Ec of the cap rubber portion.

10. The non-pneumatic tire according to claim 3,
wherein the elastic modulus Eb of the base rubber portion is lower than the elastic modulus Ec of the cap rubber portion.

11. The non-pneumatic tire according to claim 4,
wherein the elastic modulus Eb of the base rubber portion is lower than the elastic modulus Ec of the cap rubber portion.

12. The non-pneumatic tire according to claim 5,
wherein the elastic modulus Eb of the base rubber portion is lower than the elastic modulus Ec of the cap rubber portion.

13. The non-pneumatic tire according to claim 6,
wherein the elastic modulus Eb of the base rubber portion is lower than the elastic modulus Ec of the cap rubber portion.

14. The non-pneumatic tire according to claim 9,
wherein the elastic modulus Eb of the base rubber portion and the elastic modulus Ec of the cap rubber portion satisfy 0.1 MPa<Eb<Ec<100 MPa.

15. The non-pneumatic tire according to claim 10,
wherein the elastic modulus Eb of the base rubber portion and the elastic modulus Ec of the cap rubber portion satisfy 0.1 MPa<Eb<Ec<100 MPa.

16. The non-pneumatic tire according to claim 11,
wherein the elastic modulus Eb of the base rubber portion and the elastic modulus Ec of the cap rubber portion satisfy 0.1 MPa<Eb<Ec<100 MPa.

17. The non-pneumatic tire according to claim 12,
wherein the elastic modulus Eb of the base rubber portion and the elastic modulus Ec of the cap rubber portion satisfy 0.1 MPa<Eb<Ec<100 MPa.

18. The non-pneumatic tire according to claim 13,
wherein the elastic modulus Eb of the base rubber portion and the elastic modulus Ec of the cap rubber portion satisfy 0.1 MPa<Eb<Ec<100 MPa.
